(19) United States
(12) Patent Application Publication
(10) Pub. No.: US 2024/0378372 A1
(43) Pub. Date: Nov. 14, 2024

(54) TEXT PROCESSING METHOD AND APPARATUS, ELECTRONIC DEVICE, AND STORAGE MEDIUM

(71) Applicant: BEIJING ZITIAO NETWORK TECHNOLOGY CO., LTD., Haidian District (CN)

(72) Inventor: Ruchong LUO, Beijing (CN)

(21) Appl. No.: 18/660,663

(22) Filed: May 10, 2024

(30) Foreign Application Priority Data
May 11, 2023 (CN) 202310533384.2

(51) Int. Cl. G06F 40/166; G06F 3/04842; G06F 40/30

(52) U.S. Cl. CPC G06F 40/166; G06F 3/04842; G06F 40/30

(57) ABSTRACT

Embodiments of the present disclosure provide a text processing method and apparatus, an electronic device, and a storage medium. The text processing method includes: acquiring and displaying a text to be processed, in which the text to be processed includes a plurality of words, and each of the plurality of words includes at least one character; determining a spacing adjustment object corresponding to the text to be processed in response to a spacing adjustment triggering operation for the text to be processed, in which the spacing adjustment object includes a word spacing and a character spacing that make up the text to be processed; adjusting the spacing adjustment object, updating the text to be processed based on an adjustment result, and displaying the text to be processed after the updating.

### CROSS-REFERENCE TO RELATED APPLICATION

The present application claims the priority to Chinese Patent Application No. 202310533384.2, filed on May 11, 2023, the entire disclosure of which is incorporated herein by reference as portion of the present application.

### TECHNICAL FIELD

Embodiments of the present disclosure relate to a text processing technology, and in particular, to a text processing method and apparatus, an electronic device, and a storage medium.

### BACKGROUND

Text, as one of major information carrying means, has been widely applied to various fields. For example, in the image processing field, image showing effects may be enriched by adding a text to an image.

In a text edited by a related technique, a character spacing between characters in the text is often a default spacing. In a scenario of modifying the character spacing, the cursor needs to be placed between two characters to be modified to adjust the character spacing by adding or deleting a space. Such the modification way is time-consuming and laborious for the adjustment of a plurality of character spacings in a text, affecting the user experience.

### SUMMARY

The present disclosure provides a text processing method and apparatus, an electronic device, and a storage medium to realize flexible adjustment of a character spacing or a word spacing of a text.

In a first aspect, the embodiments of the present disclosure provide a text processing method, and the method include:
acquiring and displaying a text to be processed, in which the text to be processed includes a plurality of words, and each of the plurality of words includes at least one character;
determining a spacing adjustment object corresponding to the text to be processed in response to a spacing adjustment triggering operation for the text to be processed, in which the spacing adjustment object includes a word spacing and a character spacing that make up the text to be processed; and
adjusting the spacing adjustment object, updating the text to be processed based on an adjustment result, and displaying the text to be processed after the updating.

In a second aspect, the embodiments of the present disclosure further provide a text processing apparatus, and the apparatus include:
a text acquisition module, configured to acquire and display a text to be processed, in which the text to be processed includes a plurality of words, and each of the plurality of words includes at least one character;
a spacing adjustment module, configured to determine a spacing adjustment object corresponding to the text to be processed in response to a spacing adjustment triggering operation for the text to be processed, in which the spacing adjustment object includes a word spacing and a character spacing that make up the text to be processed; and
a display updating module, configured to adjust the spacing adjustment object, update the text to be processed based on an adjustment result, and display the text to be processed after the text to be processed is updated.

In a third aspect, the embodiments of the present disclosure further provide an electronic device, and the electronic device includes:
one or more processors; and
a storage apparatus, configured to store one or more programs;
the one or more programs, when executed by the one or more processors, enable the one or more processors to implement the text processing method according to any one of the embodiments of the present disclosure.

In a fourth aspect, the embodiments of the present disclosure further provide a storage medium including computer-executable instructions, and the computer-executable instructions, when executed by a computer processor, are configured to implement the text processing method according to any one of the embodiments of the present disclosure.

### BRIEF DESCRIPTION OF DRAWINGS

The above and other features, advantages and aspects of different embodiments of the present disclosure will become more apparent from the drawings and the following specific embodiments. Identical or similar reference numerals indicate identical or similar elements throughout the drawings. It should be understood that the drawings are illustrative, and components and elements are not necessarily drawn to scale.

FIG. 1 is a schematic flowchart of a text processing method provided by the embodiments of the present disclosure;

FIG. 2 is a schematic flowchart of another text processing method provided by the embodiments of the present disclosure;

FIG. 3 is a schematic flowchart of another text processing method provided by the embodiments of the present disclosure;

FIG. 4 is a schematic flowchart of another text processing method provided by the embodiments of the present disclosure;

FIG. 5 is a schematic structural diagram of a text processing apparatus provided by the embodiments of the present disclosure; and

FIG. 6 is a schematic structural diagram of an electronic device provided by the embodiments of the present disclosure.

### DETAILED DESCRIPTION

Embodiments of the present disclosure will be described in more detail below with reference to the drawings. While certain embodiments of the present disclosure are shown in the drawings, it should be understood that the present disclosure may be embodied in various forms and should not be construed as limited to the embodiments set forth herein. Rather, these embodiments are provided for a thorough and complete understanding of the present disclosure. It should be understood that the drawings and embodiments of the present disclosure are only for exemplary purposes and are not intended to limit the protection scope of the present disclosure.

It should be understood that the various steps described in the method embodiments of the present disclosure may be performed in different orders and/or in parallel. Furthermore, the method embodiments may include additional steps and/or omit performing the illustrated steps. The protection scope of the present disclosure is not limited in this aspect.

As used herein, the term “include,” “comprise,” and variations thereof are open-ended inclusions, i.e., “including but not limited to.” The term “based on” is “based, at least in part, on.” The term “an embodiment” represents “at least one embodiment,” the term “another embodiment” represents “at least one additional embodiment,” and the term “some embodiments” represents “at least some embodiments.” Relevant definitions of other terms will be given in the description below.

It should be noted that concepts such as the “first,” “second,” or the like mentioned in the present disclosure are only used to distinguish different devices, modules or units, and are not used to limit the interdependence relationship or the order of functions performed by these devices, modules or units.

It should be noted that the modifications of “a,” “an,” “a plurality of,” or the like mentioned in the present disclosure are illustrative rather than restrictive, and those skilled in the art should understand that unless the context clearly indicates otherwise, these modifications should be understood as “one or more.”

The names of the messages or information exchanged between a plurality of apparatuses in the embodiments of the present disclosure are for illustrative purposes only and are not intended to limit the scope of these messages or information.

It may be understood that before using the technical solutions disclosed in the embodiments of the present disclosure, it is necessary to inform user(s) the types, using scope, and using scenarios of personal information involved in the present disclosure according to relevant laws and regulations in an appropriate manner and obtain the authorization of the user(s).

For example, in response to receiving a user's active request, a prompt message is sent to the user to clearly remind the user that the requested operation will require acquiring and using the user's personal information. Thus, users can selectively choose whether to provide personal information to the software or hardware such as an electronic device, an application, a server, or a storage medium that perform the operations of the technical solutions of the present disclosure according to the prompt message.

As an optional but non-restrictive implementation, in response to receiving the user's active request, sending the prompt message to the user may be done in the form of a pop-up window, where the prompt message may be presented in text. In addition, the pop-up window may further carry a selection control for users to choose between “agree” or “disagree” to provide the personal information to an electronic device.

It may be understood that the above-mentioned processes of informing and acquiring user authorization are only illustrative and do not limit the embodiments of the present disclosure. Other methods that comply with relevant laws and regulations may also be applied to the embodiments of the present disclosure.

It may be understood that the data involved in the technical solutions (including but not limited to the data itself, data acquisition or use) should comply with the requirements of corresponding laws, regulations and relevant provisions.

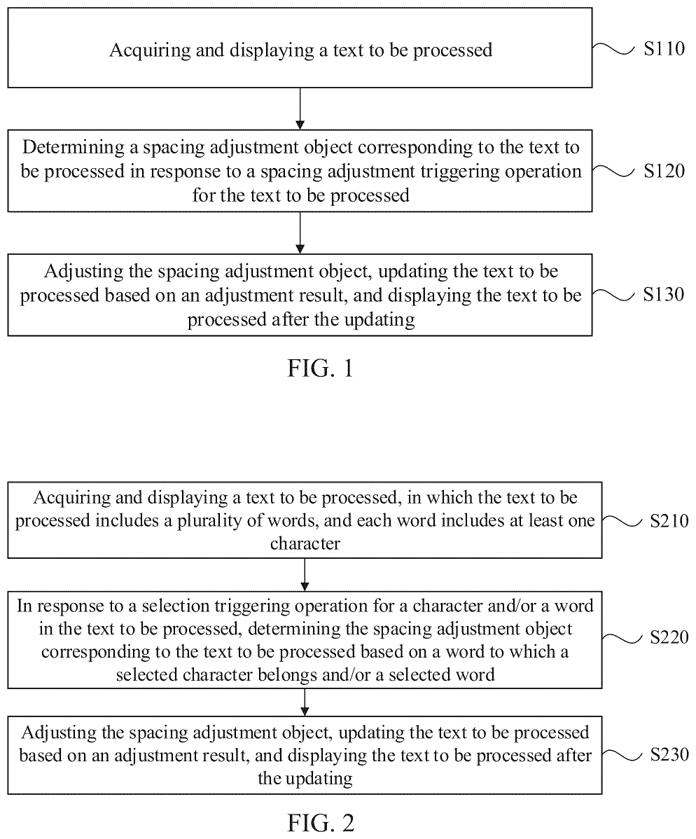

FIG. 1 is a schematic flowchart of a text processing method provided by the embodiments of the present disclosure. The present embodiment of the present disclosure is applicable to a scenario of modifying a word spacing and/or a character spacing in a text. The text processing method may be performed by a text processing apparatus that may be implemented in the form of software and/or hardware, and optionally implemented by an electronic device. The electronic device may be a mobile terminal, a personal computer (PC) terminal, a server, or the like.

As shown in FIG. 1, the text processing method of the present embodiment may include the following steps.

S110, acquiring and displaying a text to be processed.

The text to be processed may be construed as a text to be adjusted on spacing at a current moment. The text to be processed may include text components of a plurality of levels. The text components may be construed as units that make up the text. Exemplarily, according to different levels, the units that make up the text may be characters, words, phrases, sentences, or the like. That is, the text components may include but are not limited to characters, words, phrases, sentences, or the like. The text to be processed includes a plurality of words and each word includes at least one character. Exemplarily, assuming that the text to be processed is “Tomorrow is another day”, the words included in the text to be processed are “Tomorrow”, “is”, “another”, and “day”, and characters in the word “Tomorrow” are T, o, m, o, r, r, o, and w. Exemplarily, assuming that the text to be processed is “ [symbol] ”, the Chinese words included in the text to be processed are “ [symbol] ”, “ [symbol] ”, “ [symbol] ”, and “ [symbol] ”, and the Chinese characters in the Chinese word “ [symbol] ” are “ [symbol] ” and “ [symbol] ”.

Optionally, after the text to be processed is acquired, the text processing method further includes: identifying the text to be processed to determine a plurality of text components in the text to be processed. Exemplarily, a preset object of the text to be processed is identified and the identified preset object is taken as a text component. Specifically, the text to be processed may be divided into words to obtain words corresponding to the text to be processed, and the word is taken as a text component. Further, characters that make up the text to be processed may be identified and each character in a word is taken as a text component. Characters may be construed as the minimum units that make up the text. Optionally, the text to be processed is divided into words based on a semantic recognition technique.

Optionally, a phrase in the text to be processed is determined, and the phrase is taken as a text component. Determining the phrase in the text to be processed may be, in response to a phrase selection operation for the text to be processed, determining the phrase in the text to be processed based on the phrase selection operation; or may be determining the phrase in the text to be processed based on semantic recognition of the context.

As described above, there are numerous scenarios involving the use of a text.

Therefore, the text to be processed may be a text acquired in a variety of scenarios. For example, the text to be processed may be a text in a document, a text added to an image in the form of a text box, a text included in an image or an article (such as a book, a business card, an article label, or a packaging box) itself, or a caption text corresponding to an audio and a video.

From the perspective of a language type, the text to be processed may be a text that is made up of a single language type or a text that is made up of a plurality of language types. From the perspective of a text style, the text to be processed may be a text that is made up of spacing adjustment objects of a single style or a text that is made up of spacing adjustment objects of a plurality of styles.

Optionally, acquiring the text to be processed includes at least one of the following operations:
performing text recognition on a first object including a text to obtain the text to be processed;
taking the selected text as the text to be processed in response to a text selection triggering operation; and
in case of receiving a text sent by a second object, taking the received text as the text to be processed.

The first object may be any object including a text, such as an image or an article as described above. The second object may be any object having a text sending function, e.g., a text sending object in a scenario such as an operator, a mailbox, or instant messaging application software. It should be noted that the above is merely the description of examples of the first object and the second object. What objects the first object and the second object are may be determined according to an actual scenario, which is not limited here.

The text selection triggering operation may be construed as a triggering operation for selecting the text to be processed. Exemplarily, taking the selected text as the text to be processed in response to the text selection triggering operation may be, in response to a drawing triggering operation of drawing a selection region box based on an input device, taking a text located in the drawn selection region box as the text to be processed; or may be, in response to a selection triggering operation for text components, taking a text to which the selected text component belongs as the text to be processed.

S120, determining a spacing adjustment object corresponding to the text to be processed in response to a spacing adjustment triggering operation for the text to be processed.

The spacing adjustment object may be construed as a spacing type corresponding to a spacing to be adjusted. In an embodiment of the present disclosure, the spacing adjustment object may include a word spacing and a character spacing. On this basis, the spacing adjustment object may also include a row spacing or a column spacing.

The spacing adjustment triggering operation may be construed as a triggering operation for adjusting a distance of the spacing adjustment objects in the text to be processed. The spacing adjustment triggering operation may be generated in a plurality of ways. For example, the spacing adjustment triggering operation may be generated by a selection operation on the text components in the text to be processed, or generated by a setting operation for some preset spacing adjustment setting items. Exemplarily, the selection operation for the text components in the text to be processed may be a selection operation for at least part of characters or at least part of words of the text components.

Specifically, determining the spacing adjustment object corresponding to the text to be processed in response to the spacing adjustment triggering operation for the text to be processed may include: displaying a spacing adjustment setting item corresponding to the text to be processed, and in response to an information setting triggering operation for the spacing adjustment setting item, determining the spacing adjustment object corresponding to the text to be processed based on setting information corresponding to the spacing adjustment setting item. The advantages of this setting are as follows: different spacing adjustment dimensions can be provided for the user by the spacing adjustment setting item; precise matching of the spacing adjustment object in the text to be processed can be realized automatically with the setting information corresponding to the spacing adjustment setting item; thus, the spacing adjustment intention of the user can be accurately acquired; and the operation is simple and convenient.

The spacing adjustment setting item may be construed as a function item for settable parameter information associated with the spacing adjustment object. There may be one or more spacing adjustment setting items. Exemplarily, the spacing adjustment setting item may be a setting item corresponding to the spacing adjustment object and/or a setting item corresponding to a text component associated with the spacing adjustment object.

Exemplarily, the setting item corresponding to the spacing adjustment object may be a setting item corresponding to the spacing type (e.g., the character spacing and the word spacing) of the spacing adjustment object and/or a setting item corresponding to a distance value (e.g., the amount of characters or a value corresponding to a length unit) of the spacing adjustment object.

The setting item corresponding to the text component may include but be not limited to at least one of setting items such as a setting item corresponding to the language type (such as Chinese, English, Japanese, or Korean) of the text component, a setting item corresponding to the font style (including a font style and a font type), a setting item corresponding to the color, and a setting item corresponding to the size.

Optionally, displaying the spacing adjustment setting item corresponding to the text to be processed may be displaying the spacing adjustment setting item and an object of the text to be processed in a target interface; or may be, in response to the spacing adjustment triggering operation for the text to be processed, adding and displaying the spacing adjustment setting item corresponding to the text to be processed in the target display; or may be, in response to the spacing adjustment triggering operation for the text to be processed, displaying the spacing adjustment setting item corresponding to the text to be processed in the form of a pop-up window.

The information setting triggering operation may be construed as a triggering operation for setting specific parameter information corresponding to each spacing adjustment setting item. Thus, the spacing adjustment object matching the setting information corresponding to the spacing adjustment setting item may be taken as the spacing adjustment object corresponding to the text to be processed.

For example, assuming that the spacing adjustment setting items include the setting item corresponding to the spacing type of the spacing adjustment object and the setting item corresponding to the language type of the text component, and the spacing type is set to the character spacing and the language type is set to Chinese based on the information setting triggering operation, the spacing adjustment object may be determined as the character spacing between every two Chinese characters in the text to be processed.

S130, adjusting the spacing adjustment object, updating the text to be processed based on an adjustment result, and displaying the text to be processed after the updating.

From the perspective of the variation trend of adjustment, optionally, adjusting the spacing adjustment object includes increasing or reducing a distance value corresponding to the spacing adjustment object.

From the perspective of the variation amount of adjustment, adjusting the spacing adjustment object may be adjusting the distance value corresponding to the spacing adjustment object to a target value. Specifically, a current value and a target value of the distance value corresponding to the spacing adjustment object may be acquired, a difference between the current value and the target value may be calculated, and the current value may be adjusted to the target value based on the difference. Alternatively, adjusting the spacing adjustment object may be increasing or reducing the distance value corresponding to the spacing adjustment object by a preset value.

Optionally, in response to the spacing adjustment object being the word spacing, a current word to be adjusted and a previous word of the current word to be adjusted in the text to be processed are determined; and the position information of the first character of the current word to be adjusted is adjusted based on the position information of the last character of the previous word, to adjust the word spacing.

It may be understood that the text to be processed generally includes a plurality of words. The word spacing may be construed as a spacing between every two adjacent words. Specifically, the word spacing may be a distance between the last character of a former one and the first character of a latter one of two adjacent words. The word spacing to be adjusted may be a word spacing between part of words in the text to be processed or may be a word spacing between all words in the text to be processed. For the current word to be adjusted, the position information of the first character of the current word to be adjusted may be adjusted with reference to the position information of the last character of the adjacent previous word of the current word to be adjusted in the text to be processed.

Optionally, in response to the spacing adjustment object being the character spacing, the character corresponding to the character spacing to be adjusted is determined, the word corresponding to the character is acquired, and a word center position corresponding to the word is determined; a first distance from each character in the word to the word center position is determined, and the first distance is scaled to adjust the character spacing between every two characters in the word.

Similarly, each word in the text to be processed often includes a plurality of characters. In each word, the spacing between every two adjacent characters is the character spacing. The character spacing to be adjusted may be a character spacing between part of words in the text to be processed, or may be a character spacing between all words. Further, the spacing may also be a character spacing between part of characters in a word or a character spacing between all of characters in the word.

Optionally, acquiring a word corresponding to characters includes one or more of the following operations: acquiring the word to which the character belong (or in which the character is located); acquiring all words including the character in the text to be processed; and acquiring the word to which the character belong (or in which the character is located), and acquiring the same words as the word in the text to be processed.

The word center position may be construed as the position of the center of a word, which is generally related to the length of the word. Optionally, determining the word center position corresponding to the word includes: acquiring a first position corresponding to the first character in the word and a second position corresponding to the last character in the word, and determining the word center position corresponding to the word based on the first position and the second position. Alternatively, a total number of characters included in the word and the position of each character are acquired. In response to the total number of characters included in the word being an odd number, the position of the middle character of the word is acquired as the word center position. Taking a word of 5 characters for example, the position of the third character may be taken as the word center position. In response to the total number of characters included in the word being an even number, the positions of any two characters symmetric about a center in the word are acquired to determine the word center position. Taking a word of 6 characters for example, the two characters symmetric about the center may be the first character and the sixth character, the second character and the fifth character, or the third character and the fourth character.

Specifically, the character spacing in the word may be adjusted with the word center position as a reference position, and the distance from each character in the word to the word center position is scaled to adjust the character spacing in the word. Compared with the way of adjusting position coordinate values corresponding to the characters one by one according to a relative relationship of coordinates, the adjustment of the character spacing can be realized simply and rapidly by scaling.

In an embodiment of the present disclosure, optionally, the text center position corresponding to the text to be processed after the updating is identical to the text center position corresponding to the text to be processed before the adjusting. That is, the text center position corresponding to the text to be processed before and after the spacing adjustment remains unchanged. The advantage of this setting is that the position change made on one side of the text to be processed after the updating can be prevented. The present technical solution can guarantee that the changes on two sides corresponding to the text to be processed are relatively balanced and can maintain the original display structure layout of the text to be processed as much as possible, and is particularly suitable for a scenario of adjusting the text to be processed in other information such as an image, thereby guaranteeing a relative display relationship of both and improving the visual effect of the text to be processed.

According to the technical solution of the embodiments of the present disclosure, the text to be processed is acquired and displayed, where the text to be processed includes words that make up the text to be processed and characters that make up the words. Text components of two different types (i.e., characters and words) may be used as the spacing adjustment objects, and fine division of different levels is realized for the text to be processed. The spacing adjustment object corresponding to the text to be processed is determined in response to the spacing adjustment triggering operation for the text to be processed, and the spacing adjustment object is adjusted, where the spacing adjustment object includes a word spacing and a character spacing that make up the text to be processed. The selection of the spacing adjustment object needing to be adjusted is supported based on an interactive operation such that the configuration manner of the spacing adjustment object is more flexible and can well meet the user requirement. Finally, the text to be processed is updated based on the adjustment result and the updated text to be processed is displayed. The adjusted text to be processed is visually presented so that the user can know the adjustment result of the spacing adjustment object and the resulting change of the text to be processed in time. The technical problem of time-consuming and laborious modification of the character spacing in a file in the related art is solved. Flexible modification of the spacing between characters or words in the text to be process is realized. The beneficial effects of improving the text processing efficiency and enhancing the text processing experience are achieved.

On the basis of any optional technical solution of the embodiments of the present disclosure, optionally, the text processing method further includes: in response to an information adjustment operation for second display information of a word or a character in the text to be processed, adjusting the second display information of the word or the character. The second display information may include but be not limited to at least one of information such as language type information, font style information, color information, position information, and size information corresponding to the word or the character. The advantages of this setting are as follows: the adjustment of different dimensions of the text to be processed is realized and the adjustment ways for the text to be processed are increased, thus enriching the display effects of the text to be processed from a plurality of dimensions.

In some scenarios, the words or the characters in the text to be processed may be grouped according to the second display information corresponding to the words or the characters. For example, when the character spacing is adjusted, in case of a trigger character being determined, a character having the same second display information with the trigger character in the text to be processed may be acquired as an associated character, and then a reference character and the associated character are taken as a group of spacing adjustment objects. Similarly, in case of a trigger word being determined, a word having the same second display information with the trigger word in the text to be processed may be acquired as an associated word, and then the trigger word and the associated word are taken as a group of spacing adjustment objects.

With the present technical solution, differentiated processing and batching processing of the spacing adjustment objects in the text to be processed may be realized. Not only can the display effects of the text to be processed be enriched, but also the processing efficiency of the text to be processed can be improved. The text processing experience of the user can be further enhanced.

FIG. 2 is a schematic flowchart of another text processing method provided by the embodiments of the present disclosure. The technical solution of the present embodiment involves a further refinement of how to determine the spacing adjustment object of the text to be processed on the basis of any optional embodiment. Optionally, determining the spacing adjustment object corresponding to the text to be processed in response to the spacing adjustment triggering operation for the text to be processed includes: in response to a selection triggering operation for a character and/or a word in the text to be processed, determining the spacing adjustment object corresponding to the text to be processed based on a word to which a selected character belongs and/or a selected word. The specific implementation may be referred to the description in the present embodiment. The technical features identical or similar to those in the foregoing embodiments will not be repeatedly described.

As shown in FIG. 2, the text processing method of the present embodiment may specifically include the following steps.

S210, acquiring and displaying a text to be processed, in which the text to be processed includes a plurality of words, and each word includes at least one character.

S220, in response to a selection triggering operation for a character and/or a word in the text to be processed, determining the spacing adjustment object corresponding to the text to be processed based on a word to which a selected character belongs and/or a selected word.

The selection triggering operation may be construed as a triggering operation for selecting a text component associated with the spacing adjustment object in the text to be processed. Specifically, the selection triggering operation for the character and/or the word in the text to be processed includes: a selection triggering operation for part of characters in a word in the text to be processed; a selection triggering operation for a preset number of complete words in the text to be processed; and a selection triggering operation for a preset number of complete words and part of characters in part of words in the text to be processed.

Optionally, determining the spacing adjustment object corresponding to the text to be processed based on the word to which the selected character belongs and/or the selected word includes: taking the word to which the selected character belongs and/or the selected word as at least one trigger word and determining an amount of the at least one trigger word; and determining at least two spacing adjustment objects in the text to be processed based on the amount of the at least one trigger word.

The trigger word may be construed as the word to which the character selected directly or the word selected directly based on the selection triggering operation. It may be understood that there may be one or more selected trigger words. The positions of a plurality of trigger words in the text to be processed may be adjacent or not adjacent. Further, in case of a plurality of trigger words being present, at last two spacing adjustment objects in the text to be processed may also be determined according to an adjacent relationship of the plurality of trigger words. The adjacent relationship includes adjacent and not adjacent.

Exemplarily, determining the spacing adjustment object corresponding to the text to be processed based on the amount of the at least one trigger word includes at least one of the following operations:
in response to the amount of the at least one trigger word being one, taking the character spacing as the spacing adjustment object;
in response to the amount of the at least one trigger word being plural, taking the word spacing as the spacing adjustment object;
in response to the amount of the at least one trigger word being plural and at least part of the at least one trigger word being not adjacent in the text to be processed, taking the character spacing as the spacing adjustment object;
in response to the amount of the at least one trigger word being plural and at least part of the at least one trigger word being adjacent in the text to be processed, taking the word spacing as the spacing adjustment object.

Specifically, at least part of the at least one trigger word being not adjacent in the text to be processed may include that a plurality of trigger words are all not adjacent in the text to be processed, or part of the trigger words in the text to be processed are not adjacent. Similarly, at least part of the at least one trigger word being adjacent in the text to be processed may include that a plurality of trigger words are all adjacent in the text to be processed, or part of the trigger words in the text to be processed are adjacent.

S230, adjusting the spacing adjustment object, updating the text to be processed based on an adjustment result, and displaying the text to be processed after the updating.

According to the technical solution of the embodiments of the present disclosure, in response to the selection triggering operation for the character and/or word in the text to be processed, the spacing adjustment object corresponding to the text to be processed is determined based on the word to which the selected character belongs and/or the selected word. The character and/or word of interest by the user in the text to be processed can be accurately captured. Thus, the spacing adjustment object in the text to be processed can be determined and adjusted such that the adjustment result meets the user requirement, thereby enhancing the text processing experience of the user.

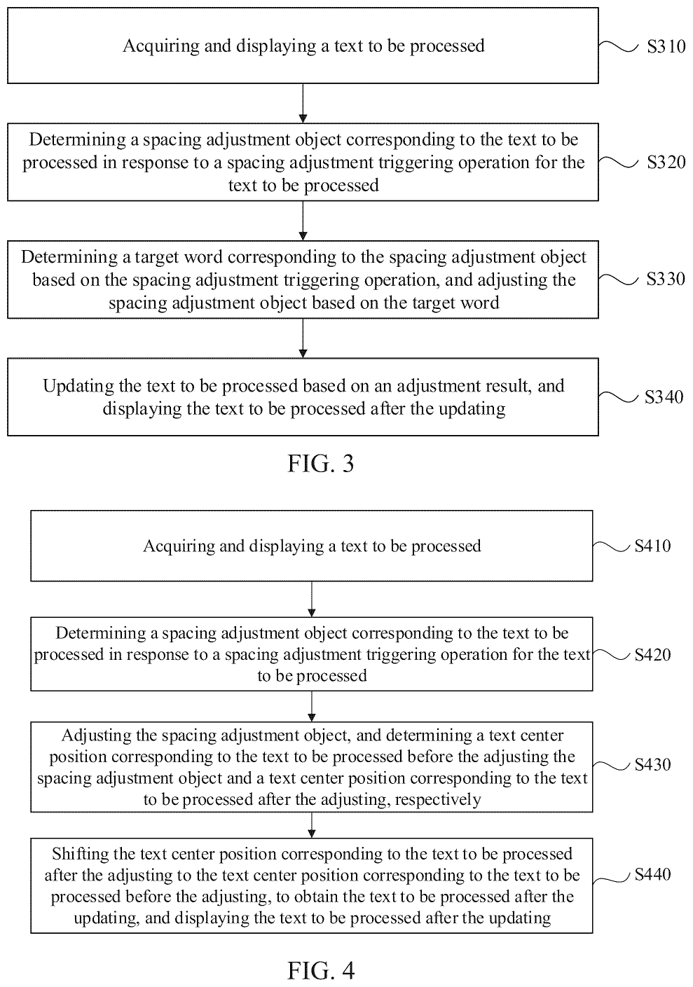

FIG. 3 is a schematic flowchart of another text processing method provided by the embodiments of the present disclosure. The technical solution of the present embodiment involves a further refinement of the adjustment way of the spacing adjustment object on the basis of the foregoing embodiments. Optionally, a target word corresponding to the spacing adjustment object is determined based on the spacing adjustment triggering operation, and the spacing adjustment object is adjusted based on the target word. The specific implementation may be referred to the description in the present embodiment. The technical features identical or similar to those in the foregoing embodiments will not be repeatedly described.

As shown in FIG. 3, the text processing method of the present embodiment may specifically include the following steps.

S310, acquiring and displaying a text to be processed.

S320, determining a spacing adjustment object corresponding to the text to be processed in response to a spacing adjustment triggering operation for the text to be processed.

S330, determining a target word corresponding to the spacing adjustment object based on the spacing adjustment triggering operation, and adjusting the spacing adjustment object based on the target word.

The target word may be construed as a word associated with the spacing adjustment object to be adjusted in the text to be processed. Optionally, determining the target word corresponding to the spacing adjustment object based on the spacing adjustment triggering operation includes: determining a trigger word in the text to be processed based on the spacing adjustment triggering operation, and determining the target word corresponding to the spacing adjustment object based on the trigger word. Exemplarily, the text component selected by the spacing adjustment triggering operation may be taken as a trigger word. Alternatively, a screening rule corresponding to the spacing adjustment object is determined based on the spacing adjustment triggering operation, and the target word corresponding to the spacing adjustment object in the text to be processed is determined based on the screening rule. The screening rule includes a rule associated with display information corresponding to the screened text component and/or a rule associated with an object information item corresponding to the spacing adjustment object. The object information includes a spacing type and/or a spacing length corresponding to the spacing adjustment object. For example, in the screening rule, the word spacing less than a preset spacing length in the text to be processed may be taken as the spacing adjustment object to be adjusted. In this case, a word with a word spacing less than the preset spacing length may be taken as the target word.

Specifically, determining the target word corresponding to the spacing adjustment object based on the trigger word includes: determining the trigger word as the target word corresponding to the spacing adjustment object; or determining an associated word corresponding to the trigger word in the text to be processed based on first display information corresponding to the trigger word, and taking the trigger word and the associated word as the target words corresponding to the spacing adjustment object, where the first display information includes at least one of a language type corresponding to the trigger word, a font style corresponding to the trigger word, a color corresponding to the trigger word, a size corresponding to the trigger word, and combination structure information between adjacent trigger words.

The combination structure information may be construed as overall structure representation information between adjacent trigger words. Specifically, the combination structure information may be a feature combination form or a feature change manner expressed in the adjacent trigger words by the feature of each trigger word of a combination determined according to preset dimensions. Exemplarily, the combination structure information may be a combination characteristic of language types between the adjacent trigger words, such as a same language type, or a combination of different language types. Optionally, a word in conformity with the combination characteristic of language types in the text to be processed is taken as the associated word corresponding to the trigger word in the text to be processed. For example, the combination characteristic of language types is a Chinese-English combination, and all adjacent words of which the former one is Chinese and the latter one is English in the text to be processed may be taken as the associated words corresponding to the trigger word in the text to be processed.

S340, updating the text to be processed based on an adjustment result, and displaying the text to be processed after the updating.

According to the technical solution of the embodiments of the present disclosure, the target word corresponding to the spacing adjustment object is determined based on the spacing adjustment triggering operation. In this way, the target word to be adjusted in the text to be processed may be accurately determined by interaction, and then the spacing adjustment object to be adjusted can be accurately localized. The spacing adjustment object is adjusted based on the target word so that the adjustment of the spacing adjustment object can be realized by means of the position adjustment of the target word. Accordingly, the display effect of the text to be processed can be guaranteed.

FIG. 4 is a schematic flowchart of another text processing method provided by the embodiments of the present disclosure. On the basis of the foregoing optional embodiments, the technical solution of the present embodiment may keep the text center position of the text to be processed unchanged. The present embodiment involves a further refinement of how to realize that the text center position corresponding to the text to be processed after the updating is identical to the text center position corresponding to the text to be processed before the adjusting. Optionally, updating the text to be processed based on the adjustment result includes: determining a text center position corresponding to the text to be processed before the adjusting the spacing adjustment object and a text center position corresponding to the text to be processed after the adjusting, respectively; and shifting the text center position corresponding to the text to be processed after the adjusting to the text center position corresponding to the text to be processed before the adjusting, to obtain the text to be processed after the updating. The specific implementation may be referred to the description in the present embodiment. The technical features identical or similar to those in the foregoing embodiments will not be repeatedly described.

As shown in FIG. 4, the text processing method of the present embodiment may specifically include the following steps.

S410, acquiring and displaying a text to be processed.

S420, determining a spacing adjustment object corresponding to the text to be processed in response to a spacing adjustment triggering operation for the text to be processed.

S430, adjusting the spacing adjustment object, and determining a text center position corresponding to the text to be processed before the adjusting the spacing adjustment object and a text center position corresponding to the text to be processed after the adjusting, respectively.

After the adjusting may be construed as after adjusting at least part of the spacing adjustment objects. Optionally, after the adjusting is after completing the spacing adjustment corresponding to the spacing adjustment triggering operation. The text center position may be construed as the position of the center of a display position of the text to be processed, which is generally related to the length of the text to be processed.

Optionally, for the text to be processed before the adjusting or the text to be processed after the updating, the text center position corresponding to the text to be processed is determined based on the word center position corresponding to the word in the text to be processed. Specifically, a reference word in the text to be processed is determined and the word center position corresponding to the reference word is determined. The text center position corresponding to the text to be processed is determined based on the word center position corresponding to the reference word in the text to be processed.

The reference word may be construed as a word used for determining the text center position of the text to be processed. For the reference word in the text to be processed, a determination way of the word center position of the reference word may be realized based on the technical solution for the word center position of the word in the text to be processed in the foregoing embodiments, which will not be described redundantly here.

Optionally, a total number of words included in the text to be processed and the word center position of each word are acquired. In response to the total number of words included in the text to be processed being an odd number, the word center position of the middle word of the text to be processed is acquired as the center position of the text to be processed. Taking a text to be processed of 3 words for example, the word center position of the second word may be taken as the center position of the text to be processed. In response to the total number of words included in the text to be processed being an even number, the word center positions of any two words symmetric about a center in the text to be processed are acquired to determine the center position of the text to be processed. Taking a text to be processed of 4 words for example, the two words symmetric about the center may be the second word and the third word, or the first word and the fourth word.

Optionally, determining the text center position corresponding to the text to be processed includes: acquiring the position of the first character in the text to be processed as a third position; and acquiring the position of the last character in the text to be processed as a fourth position, and determining the text center position corresponding to the text based on the third position and the fourth position.

S440, shifting the text center position corresponding to the text to be processed after the adjusting to the text center position corresponding to the text to be processed before the adjusting, to obtain the text to be processed after the updating, and displaying the text to be processed after the updating.

Specifically, a position offset between the text center position corresponding to the text to be processed after the adjusting and the text center position corresponding to the text to be processed before the adjusting may be calculated. The text center position corresponding to the text to be processed after the adjusting is then shifted based on the position offset such that the text center position corresponding to the text to be processed after the adjusting is shifted in alignment with the text center position corresponding to the text to be processed before the adjusting.

According to the technical solution of the embodiments of the present disclosure, after the spacing adjustment object is adjusted, the text center positions corresponding to the text to be processed before and after adjusting the spacing adjustment object are determined, respectively such that the text center position of the text to be processed before the adjusting is consistent with the text center position of the text to be processed after the adjusting. The position change made on one side of the text to be processed after the updating can be prevented. The present technical solution can guarantee that the changes on two sides corresponding to the text to be processed are relatively balanced and can maintain the original display structure layout of the text to be processed as much as possible, and is particularly suitable for a scenario of adjusting the text to be processed in other information such as an image, thereby guaranteeing a relative display relationship of both and improving the visual effect of the text to be processed.

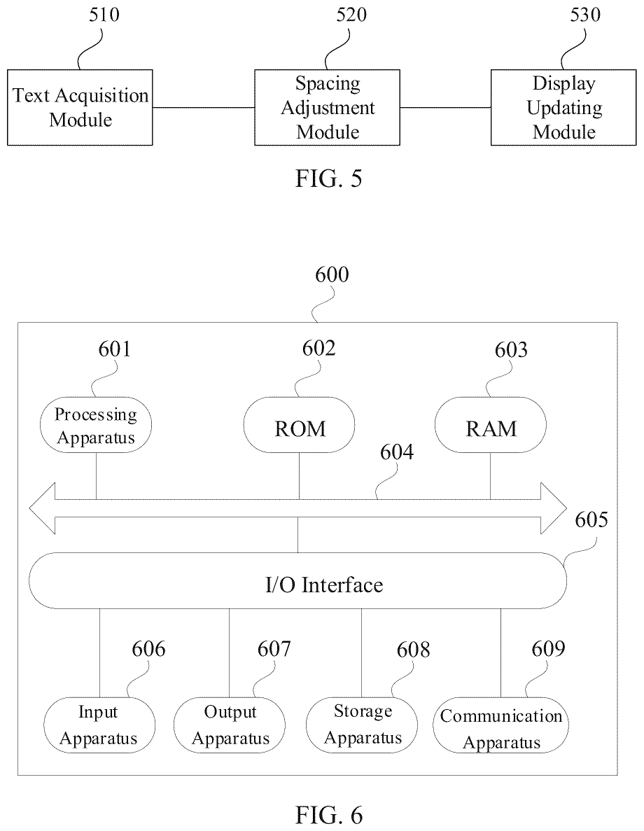

FIG. 5 is a structural schematic diagram of a text processing apparatus provided by the embodiments of the present disclosure. As shown in FIG. 5, the text processing apparatus includes a text acquisition module 510, a spacing adjustment module 520, and a display updating module 530.

The text acquisition module 510 is configured to acquire and display a text to be processed, where the text to be processed includes a plurality of words and each word includes at least one character. The spacing adjustment module 520 is configured to determine a spacing adjustment object corresponding to the text to be processed in response to a spacing adjustment triggering operation for the text to be processed, where the spacing adjustment object includes a word spacing and a character spacing that make up the text to be processed. The display updating module 530 is configured to adjust the spacing adjustment object, update the text to be processed based on an adjustment result, and display the text to be processed after the text to be processed is updated.

According to the technical solution of the embodiments of the present disclosure, the text to be processed is acquired and displayed, where the text to be processed includes words that make up the text to be processed and characters that make up the words. Text components of two different types (i.e., characters and words) may be used as the spacing adjustment objects, and fine division of different levels is realized for the text to be processed. The spacing adjustment object corresponding to the text to be processed is determined in response to the spacing adjustment triggering operation for the text to be processed, and the spacing adjustment object is adjusted, where the spacing adjustment object includes a word spacing and a character spacing that make up the text to be processed. The selection of the spacing adjustment object needing to be adjusted is supported based on an interactive operation such that the configuration manner of the spacing adjustment object is more flexible and can well meet the user requirement. Finally, the text to be processed is updated based on the adjustment result and the updated text to be processed is displayed. The adjusted text to be processed is visually presented so that the user can know the adjustment result of the spacing adjustment object and the resulting change of the text to be processed in time. The technical problem of time-consuming and laborious modification of the character spacing in a file in the related art is solved. Flexible modification of the spacing between characters or words in the text to be process is realized. The beneficial effects of improving the text processing efficiency and enhancing the text processing experience are achieved.

On the basis of any optional technical solution of the embodiments of the present disclosure, the spacing adjustment module 520 may be configured to:
in response to a selection triggering operation for a character and/or a word in the text to be processed, determine the spacing adjustment object corresponding to the text to be processed based on a word to which a selected character belongs and/or a selected word.

On the basis of any optional technical solution of the embodiments of the present disclosure, the spacing adjustment module 520 may include a trigger word determination unit and an adjustment object determination unit. The trigger word determination unit is configured to take the word to which the selected character belongs and/or the selected word as at least one trigger word and determine the amount of the at least one trigger word. The adjustment object determination unit is configured to determine the spacing adjustment object corresponding to the text to be processed based on the amount of the at least one trigger word.

On the basis of any optional technical solution of the embodiments of the present disclosure, the adjustment object determination unit is configured to perform at least one of the following operations:
in response to the amount of the at least one trigger word being one, taking the character spacing as the spacing adjustment object;
in response to the amount of the at least one trigger word being plural, taking the word spacing as the spacing adjustment object;
in response to the amount of the at least one trigger word being plural and at least part of the at least one trigger word being not adjacent in the text to be processed, taking the character spacing as the spacing adjustment object;
and in response to the amount of the at least one trigger word being plural and at least part of the at least one trigger word being adjacent in the text to be processed, taking the word spacing as the spacing adjustment object.

On the basis of any optional technical solution of the embodiments of the present disclosure, the display updating module 530 may be configured to:
determine a target word corresponding to the spacing adjustment object based on the spacing adjustment triggering operation, and adjust the spacing adjustment object based on the target word.

On the basis of the above optional technical solution, the display updating module 530 may be specifically configured to:
determine a trigger word in the text to be processed based on the spacing adjustment triggering operation, and determine the target word corresponding to the spacing adjustment object based on the trigger word.

On the basis of the above optional technical solution, the display updating module 530 may be further configured to:
take the trigger word as the target word corresponding to the spacing adjustment object;
or determine an associated word corresponding to the trigger word in the text to be processed based on first display information corresponding to the trigger word, and take the trigger word and the associated word as the target word corresponding to the spacing adjustment object, where the first display information includes at least one selected from a group consisting of: a language type corresponding to the trigger word, a font style corresponding to the trigger word, a color corresponding to the trigger word, a size corresponding to the trigger word, and combination structure information between adjacent trigger words.

On the basis of any optional technical solution of the embodiments of the present disclosure, the spacing adjustment module may be configured to:
display a spacing adjustment setting item corresponding to the text to be processed, where the spacing adjustment setting item includes a setting item corresponding to the spacing adjustment object and/or a setting item corresponding to a text component associated with the spacing adjustment object;
and in response to an information setting triggering operation for the spacing adjustment setting item, determine the spacing adjustment object corresponding to the text to be processed based on setting information corresponding to the spacing adjustment setting item.

On the basis of any optional technical solution of the embodiments of the present disclosure, the display updating module may be configured to:
in response to the spacing adjustment object being the character spacing, determine a character corresponding to the character spacing to be adjusted, acquire a word corresponding to the character, and determine a word center position corresponding to the word;
and determine a first distance from each character in the word to the word center position, and scale the first distance to adjust the character spacing between every two characters in the word.

On the basis of any optional technical solution of the embodiments of the present disclosure, the display updating module may be configured to:
in response to the spacing adjustment object being the word spacing, determine a current word to be adjusted and a previous word of the current word to be adjusted in the text to be processed;
and adjust position information of the first character of the current word to be adjusted based on position information of the last word of the previous word, to adjust the word spacing.

On the basis of any optional technical solution of the embodiments of the present disclosure, optionally, a text center position corresponding to the text to be processed after the updating is identical to a text center position corresponding to the text to be processed before the adjusting.

On the basis of any optional technical solution of the embodiments of the present disclosure, the display updating module may include a text center determination unit and a text display updating unit.

The text center determination unit is configured to determine a text center position corresponding to the text to be processed before the adjusting the spacing adjustment object and a text center position corresponding to the text to be processed after the adjusting, respectively. The text display updating unit is configured to shift the text center position corresponding to the text to be processed after the adjusting to the text center position corresponding to the text to be processed before the adjusting, to obtain the text to be processed after the updating.

On the basis of any optional technical solution of the embodiments of the present disclosure, optionally, the text center determination unit includes a word center determination sub-unit and a text center determination sub-unit.

The word center determination sub-unit is configured to determine the text center position corresponding to the text to be processed based on the word center position corresponding to the words in the text to be processed.

On the basis of any optional technical solution of the embodiments of the present disclosure, the text center determination unit or the spacing adjustment module is specifically configured to:
acquire a first position corresponding to the first character in the word and a second position corresponding to the last character in the word, and determine the word center position corresponding to the word based on the first position and the second position.

On the basis of any optional technical solution of the embodiments of the present disclosure, the text processing apparatus further includes:
a text display adjustment module configured to, in response to an information adjustment operation for second display information of a word or a character in the text to be processed, adjust the second display information of the word or the character, where the second display information includes at least one of language type information, a font style, color information, position information, and size information corresponding to the word or the character.

The text processing apparatus provided by the embodiments of the present disclosure may perform the text processing method provided by any embodiment of the present disclosure, and has corresponding functional modules for performing the text processing method and corresponding beneficial effects.

It should be noted that the units and modules included in the apparatus described above are only divided according to functional logic, but are not limited to the above division, as long as corresponding functions can be implemented. In addition, names of the functional units are merely for the purpose of distinguishing from each other, but are not intended to limit the protection scope of the embodiments of the present disclosure.

FIG. 6 is a structural schematic diagram of an electronic device provided by the embodiments of the present disclosure. Referring to FIG. 6 below, FIG. 6 illustrates a schematic structural diagram of an electronic device 600 (for example, the terminal device or server in FIG. 6) suitable for implementing the embodiments of the present disclosure. The electronic devices in the embodiments of the present disclosure may include but are not limited to mobile terminals such as a mobile phone, a notebook computer, a digital broadcasting receiver, a personal digital assistant (PDA), a portable Android device (PAD), a portable media player (PMP), a vehicle-mounted terminal (e.g., a vehicle-mounted navigation terminal), and fixed terminals such as a digital TV, a desktop computer, or the like. The electronic device illustrated in FIG. 6 is merely an example, and should not pose any limitation to the functions and the range of use of the embodiments of the present disclosure.

As illustrated in FIG. 6, the electronic device 600 may include a processing apparatus 601 (e.g., a central processing unit, a graphics processing unit, etc.), which can perform various suitable actions and processing according to a program stored in a read-only memory (ROM) 602 or a program loaded from a storage apparatus 608 into a random-access memory (RAM) 603. The RAM 603 further stores various programs and data required for operations of the electronic device 600. The processing apparatus 601, the ROM 602, and the RAM 603 are interconnected through a bus 604. An input/output (I/O) interface 605 is also connected to the bus 604.

Usually, the following apparatuses may be connected to the I/O interface 605: an input apparatus 606 including, for example, a touch screen, a touch pad, a keyboard, a mouse, a camera, a microphone, an accelerometer, a gyroscope, or the like; an output apparatus 607 including, for example, a liquid crystal display (LCD), a loudspeaker, a vibrator, or the like; a storage apparatus 608 including, for example, a magnetic tape, a hard disk, or the like; and a communication apparatus 609. The communication apparatus 609 may allow the electronic device 600 to be in wireless or wired communication with other devices to exchange data. While FIG. 6 illustrates the electronic device 600 having various apparatuses, it should be understood that not all of the illustrated apparatuses are necessarily implemented or included. More or fewer apparatuses may be implemented or included alternatively.

Particularly, according to the embodiments of the present disclosure, the processes described above with reference to the flowcharts may be implemented as a computer software program. For example, the embodiments of the present disclosure include a computer program product, which includes a computer program carried by a non-transitory computer-readable medium. The computer program includes program code for performing the methods shown in the flowcharts. In such embodiments, the computer program may be downloaded online through the communication apparatus 609 and installed, or may be installed from the storage apparatus 608, or may be installed from the ROM 602. When the computer program is executed by the processing apparatus 601, the above-mentioned functions defined in the methods of some embodiments of the present disclosure are performed.

The names of the messages or information exchanged between a plurality of apparatuses in the embodiments of the present disclosure are for illustrative purposes only and are not intended to limit the scope of these messages or information.

The electronic device provided by the embodiments of the present disclosure and the text processing method provided by the above-mentioned embodiments belong to the same inventive concept, and technical details not exhaustively described in the present embodiment may be referred to the above embodiments, and the present embodiment has the same beneficial effects as the above embodiments.

The embodiments of the present disclosure further provide a computer storage medium, upon which a computer program is stored, and the computer program, when executed by a processor, implements the text processing method provided by the above-mentioned embodiments.

It should be noted that the above-mentioned computer-readable medium in the present disclosure may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination thereof. More specific examples of the computer-readable storage medium may include but not be limited to: an electrical connection with one or more wires, a portable computer disk, a hard disk, a random-access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them. In the present disclosure, the computer-readable storage medium may be any tangible medium containing or storing a program that can be used by or in combination with an instruction execution system, apparatus or device. In the present disclosure, the computer-readable signal medium may include a data signal that propagates in a baseband or as a part of a carrier and carries computer-readable program code. The data signal propagating in such a manner may take a plurality of forms, including but not limited to an electromagnetic signal, an optical signal, or any appropriate combination thereof. The computer-readable signal medium may also be any other computer-readable medium than the computer-readable storage medium. The computer-readable signal medium may send, propagate or transmit a program used by or in combination with an instruction execution system, apparatus or device. The program code contained on the computer-readable medium may be transmitted by using any suitable medium, including but not limited to an electric wire, a fiber-optic cable, radio frequency (RF) and the like, or any appropriate combination of them.

In some implementations, the client and the server may communicate with any network protocol currently known or to be researched and developed in the future such as hypertext transfer protocol (HTTP), and may communicate (via a communication network) and interconnect with digital data in any form or medium. Examples of communication networks include a local area network (LAN), a wide area network (WAN), the Internet, and an end-to-end network (e.g., an ad hoc end-to-end network), as well as any network currently known or to be researched and developed in the future.

The above-mentioned computer-readable medium may be included in the above-mentioned electronic device, or may also exist alone without being assembled into the electronic device.

The above-mentioned computer-readable medium carries one or more programs, and when the one or more programs are executed by the electronic device, the electronic device is caused to: acquire and display a text to be processed, where the text to be processed includes a plurality of words, and each of the plurality of words includes at least one character; determine a spacing adjustment object corresponding to the text to be processed in response to a spacing adjustment triggering operation for the text to be processed, where the spacing adjustment object includes a word spacing and a character spacing that make up the text to be processed; and adjust the spacing adjustment object, update the text to be processed based on an adjustment result, and display the text to be processed after the updating.

The computer program code for performing the operations of the present disclosure may be written in one or more programming languages or a combination thereof. The above-mentioned programming languages include but are not limited to object-oriented programming languages such as Java, Smalltalk, C++, and also include conventional procedural programming languages such as the “C” programming language or similar programming languages. The program code may be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or the connection may be made to an external computer (for example, through the Internet using an Internet service provider).

The flowcharts and block diagrams in the drawings illustrate the architecture, function, and operation of possible implementations of systems, methods, and computer program products according to various embodiments of the present disclosure. In this regard, each block in the flowcharts or block diagrams may represent a module, a program segment, or a portion of code, including one or more executable instructions for implementing specified logical functions. It should also be noted that, in some alternative implementations, the functions noted in the blocks may also occur out of the order noted in the drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The modules or units involved in the embodiments of the present disclosure may be implemented in software or hardware. Among them, the name of the module or unit does not constitute a limitation of the unit itself under certain circumstances.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may include or store a program for use by or in combination with an instruction execution system, apparatus or device. The machine-readable medium may be a machine-readable signal medium or a machine-readable storage medium. The machine-readable medium includes, but is not limited to, an electrical, magnetic, optical, electromagnetic, infrared, or semi-conductive system, apparatus or device, or any suitable combination of the foregoing. More specific examples of machine-readable storage medium include electrical connection with one or more wires, portable computer disk, hard disk, random-access memory (RAM), read-only memory (ROM), erasable programmable read-only memory (EPROM or flash memory), optical fiber, portable compact disk read-only memory (CD-ROM), optical storage device, magnetic storage device, or any suitable combination of the foregoing.

According to one or more embodiments of the present disclosure, Example 1 provides a text processing method including: acquiring and displaying a text to be processed, in which the text to be processed includes a plurality of words, and each of the plurality of words includes at least one character; determining a spacing adjustment object corresponding to the text to be processed in response to a spacing adjustment triggering operation for the text to be processed, in which the spacing adjustment object includes a word spacing and a character spacing that make up the text to be processed; and adjusting the spacing adjustment object, updating the text to be processed based on an adjustment result, and displaying the text to be processed after the updating.

According to one or more embodiments of the present disclosure, Example 2 provides a method according to Example 1, which further includes:
optionally, determining the spacing adjustment object corresponding to the text to be processed in response to the spacing adjustment triggering operation for the text to be processed, includes: in response to a selection triggering operation for a character and/or a word in the text to be processed, determining the spacing adjustment object corresponding to the text to be processed based on a word to which a selected character belongs and/or a selected word.

According to one or more embodiments of the present disclosure, Example 3 provides a method according to Example 2, which further includes:
optionally, determining the spacing adjustment object corresponding to the text to be processed based on the word to which the selected character belongs and/or the selected word, includes: taking the word to which the selected character belongs and/or the selected word as at least one trigger word and determining an amount of the at least one trigger word; and determining the spacing adjustment object corresponding to the text to be processed based on the amount of the at least one trigger word.

According to one or more embodiments of the present disclosure, Example 4 provides a method according to Example 3, which further includes:
optionally, determining the spacing adjustment object corresponding to the text to be processed based on the amount of the at least one trigger word includes at least one of the following operations:
in response to the amount of the at least one trigger word being one, taking the character spacing as the spacing adjustment object;
in response to the amount of the at least one trigger word being plural, taking the word spacing as the spacing adjustment object;
in response to the amount of the at least one trigger word being plural and at least part of the at least one trigger word being not adjacent in the text to be processed, taking the character spacing as the spacing adjustment object;
and in response to the amount of the at least one trigger word being plural and at least part of the at least one trigger word being adjacent in the text to be processed, taking the word spacing as the spacing adjustment object.

According to one or more embodiments of the present disclosure, Example 5 provides a method according to Example 1, which further includes:
optionally, adjusting the spacing adjustment object includes: determining a target word corresponding to the spacing adjustment object based on the spacing adjustment triggering operation, and adjusting the spacing adjustment object based on the target word.

According to one or more embodiments of the present disclosure, Example 6 provides a method according to Example 5, which further includes:
optionally, determining the target word corresponding to the spacing adjustment object based on the spacing adjustment triggering operation, includes: determining a trigger word in the text to be processed based on the spacing adjustment triggering operation, and determining the target word corresponding to the spacing adjustment object based on the trigger word.

According to one or more embodiments of the present disclosure, Example 7 provides a method according to Example 6, which further includes:
optionally, determining the target word corresponding to the spacing adjustment object based on the trigger word, includes: taking the trigger word as the target word corresponding to the spacing adjustment object; or determining an associated word corresponding to the trigger word in the text to be processed based on first display information corresponding to the trigger word, and taking the trigger word and the associated word as the target word corresponding to the spacing adjustment object, in which the first display information includes at least one selected from a group consisting of: a language type corresponding to the trigger word, a font style corresponding to the trigger word, a color corresponding to the trigger word, a size corresponding to the trigger word, and combination structure information between adjacent trigger words.

According to one or more embodiments of the present disclosure, Example 8 provides a method according to Example 1, which further includes:
optionally, determining the spacing adjustment object corresponding to the text to be processed in response to the spacing adjustment triggering operation for the text to be processed, includes: displaying a spacing adjustment setting item corresponding to the text to be processed, in which the spacing adjustment setting item includes a setting item corresponding to the spacing adjustment object and/or a setting item corresponding to a text component associated with the spacing adjustment object; and in response to an information setting triggering operation for the spacing adjustment setting item, determining the spacing adjustment object corresponding to the text to be processed based on setting information corresponding to the spacing adjustment setting item.

According to one or more embodiments of the present disclosure, Example 9 provides a method according to Example 1, which further includes:
optionally, adjusting the spacing adjustment object includes: in response to the spacing adjustment object being the character spacing, determining a character corresponding to the character spacing to be adjusted, acquiring a word corresponding to the character, and determining a word center position corresponding to the word; and determining a first distance from each character in the word to the word center position, and scaling the first distance to adjust the character spacing between every two characters in the word.

According to one or more embodiments of the present disclosure, Example 10 provides a method according to Example 9, which further includes:
optionally, determining the word center position corresponding to the word includes: acquiring a first position corresponding to a first character in the word and a second position corresponding to a last character in the word, and determining the word center position corresponding to the word based on the first position and the second position.

According to one or more embodiments of the present disclosure, Example 11 provides a method according to Example 1, which further includes:
optionally, adjusting the spacing adjustment object includes: in response to the spacing adjustment object being the word spacing, determining a current word to be adjusted and a previous word of the current word to be adjusted in the text to be processed; and adjusting position information of a first character of the current word to be adjusted based on position information of a last word of the previous word, to adjust the word spacing.

According to one or more embodiments of the present disclosure, Example 12 provides a method according to Example 1, which further includes:
optionally, a text center position corresponding to the text to be processed after the updating is identical to a text center position corresponding to the text to be processed before the adjusting.

According to one or more embodiments of the present disclosure, Example 13 provides a method according to Example 12, which further includes:
optionally, updating the text to be processed based on the adjustment result includes: determining a text center position corresponding to the text to be processed before the adjusting the spacing adjustment object and a text center position corresponding to the text to be processed after the adjusting, respectively; and shifting the text center position corresponding to the text to be processed after the adjusting to the text center position corresponding to the text to be processed before the adjusting, to obtain the text to be processed after the updating.

According to one or more embodiments of the present disclosure, Example 14 provides a method according to Example 13, which further includes:
optionally, determining the text center position corresponding to the text to be processed before the adjusting the spacing adjustment object and the text center position corresponding to the text to be processed after the adjusting respectively, includes: for the text to be processed before the adjusting or after the updating, determining the text center position corresponding to the text to be processed based on a word center position corresponding to the words in the text to be processed.

According to one or more embodiments of the present disclosure, Example 15 provides a method according to Example 1, which further includes:
optionally, in response to an information adjustment operation for second display information of a word or a character in the text to be processed, adjusting the second display information of the word or the character, in which the second display information includes at least one of language type information, a font style, color information, position information, and size information corresponding to the word or the character.

According to one or more embodiments of the present disclosure, Example 16 provides a text processing apparatus including: a text acquisition module, configured to acquire and display a text to be processed, in which the text to be processed includes a plurality of words, and each of the plurality of words includes at least one character; a spacing adjustment module, configured to determine a spacing adjustment object corresponding to the text to be processed in response to a spacing adjustment triggering operation for the text to be processed, in which the spacing adjustment object includes a word spacing and a character spacing that make up the text to be processed; and a display updating module, configured to adjust the spacing adjustment object, update the text to be processed based on an adjustment result, and display the text to be processed after the text to be processed is updated.

The above descriptions are merely preferred embodiments of the present disclosure and illustrations of the technical principles employed. Those skilled in the art should understand that the scope of disclosure involved in the present disclosure is not limited to the technical solutions formed by the specific combination of the above-mentioned technical features, and should also cover, without departing from the above-mentioned disclosed concept, other technical solutions formed by any combination of the above-mentioned technical features or their equivalents, such as technical solutions which are formed by replacing the above-mentioned technical features with the technical features disclosed in the present disclosure (but not limited to) with similar functions.

Additionally, although operations are depicted in a particular order, it should not be understood that these operations are required to be performed in a specific order as illustrated or in a sequential order. Under certain circumstances, multitasking and parallel processing may be advantageous. Likewise, although the above discussion includes several specific implementation details, these should not be interpreted as limitations on the scope of the present disclosure. Certain features that are described in the context of separate embodiments may also be implemented in combination in a single embodiment. Conversely, various features that are described in the context of a single embodiment may also be implemented in multiple embodiments separately or in any suitable sub-combinations.

Although the subject matter has been described in language specific to structural features and/or method logical actions, it should be understood that the subject matter defined in the appended claims is not necessarily limited to the specific features or actions described above. Rather, the specific features and actions described above are merely example forms of implementing the claims.

1. A text processing method, comprising:
acquiring and displaying a text to be processed, wherein the text to be processed comprises a plurality of words, and each of the plurality of words comprises at least one character;
determining a spacing adjustment object corresponding to the text to be processed in response to a spacing adjustment triggering operation for the text to be processed, wherein the spacing adjustment object comprises a word spacing and a character spacing that make up the text to be processed; and
adjusting the spacing adjustment object, updating the text to be processed based on an adjustment result, and displaying the text to be processed after the updating.

2. The text processing method according to claim 1, wherein the determining the spacing adjustment object corresponding to the text to be processed in response to the spacing adjustment triggering operation for the text to be processed, comprises:
in response to a selection triggering operation for a character and/or a word in the text to be processed, determining the spacing adjustment object corresponding to the text to be processed based on a word to which a selected character belongs and/or a selected word.

3. The text processing method according to claim 2, wherein the determining the spacing adjustment object corresponding to the text to be processed based on the word to which the selected character belongs and/or the selected word, comprises:
taking the word to which the selected character belongs and/or the selected word as at least one trigger word and determining an amount of the at least one trigger word; and
determining the spacing adjustment object corresponding to the text to be processed based on the amount of the at least one trigger word.

4. The text processing method according to claim 3, wherein the determining the spacing adjustment object corresponding to the text to be processed based on the amount of the at least one trigger word comprises at least one of the following operations:
in response to the amount of the at least one trigger word being one, taking the character spacing as the spacing adjustment object;
in response to the amount of the at least one trigger word being plural, taking the word spacing as the spacing adjustment object;
in response to the amount of the at least one trigger word being plural and at least part of the at least one trigger word being not adjacent in the text to be processed, taking the character spacing as the spacing adjustment object; and
in response to the amount of the at least one trigger word is plural and at least part of the at least one trigger word being adjacent in the text to be processed, taking the word spacing as the spacing adjustment object.

5. The text processing method according to claim 1, wherein the adjusting the spacing adjustment object comprises:
determining a target word corresponding to the spacing adjustment object based on the spacing adjustment triggering operation, and adjusting the spacing adjustment object based on the target word.

6. The text processing method according to claim 5, wherein the determining the target word corresponding to the spacing adjustment object based on the spacing adjustment triggering operation, comprises:
determining a trigger word in the text to be processed based on the spacing adjustment triggering operation, and determining the target word corresponding to the spacing adjustment object based on the trigger word.

7. The text processing method according to claim 6, wherein the determining the target word corresponding to the spacing adjustment object based on the trigger word, comprises:
taking the trigger word as the target word corresponding to the spacing adjustment object; or
determining an associated word corresponding to the trigger word in the text to be processed based on first display information corresponding to the trigger word, and taking the trigger word and the associated word as the target word corresponding to the spacing adjustment object, wherein the first display information comprises at least one selected from a group consisting of: a language type corresponding to the trigger word, a font style corresponding to the trigger word, a color corresponding to the trigger word, a size corresponding to the trigger word, and combination structure information between adjacent trigger words.

8. The text processing method according to claim 1, wherein the determining the spacing adjustment object corresponding to the text to be processed in response to the spacing adjustment triggering operation for the text to be processed, comprises:
displaying a spacing adjustment setting item corresponding to the text to be processed, wherein the spacing adjustment setting item comprises a setting item corresponding to the spacing adjustment object and/or a setting item corresponding to a text component associated with the spacing adjustment object; and
in response to an information setting triggering operation for the spacing adjustment setting item, determining the spacing adjustment object corresponding to the text to be processed based on setting information corresponding to the spacing adjustment setting item.

9. The text processing method according to claim 1, wherein the adjusting the spacing adjustment object comprises:
in response to the spacing adjustment object being the character spacing, determining a character corresponding to the character spacing to be adjusted, acquiring a word corresponding to the character, and determining a word center position corresponding to the word; and
determining a first distance from each character in the word to the word center position, and scaling the first distance to adjust the character spacing between every two characters in the word.

10. The text processing method according to claim 9, wherein the determining the word center position corresponding to the word comprises:
acquiring a first position corresponding to a first character in the word and a second position corresponding to a last character in the word, and determining the word center position corresponding to the word based on the first position and the second position.

11. The text processing method according to claim 1, wherein the adjusting the spacing adjustment object comprises:
in response to the spacing adjustment object being the word spacing, determining a current word to be adjusted and a previous word of the current word to be adjusted in the text to be processed; and
adjusting position information of a first character of the current word to be adjusted based on position information of a last word of the previous word, to adjust the word spacing.

12. The text processing method according to claim 1, wherein a text center position corresponding to the text to be processed after the updating is identical to a text center position corresponding to the text to be processed before the adjusting.

13. The text processing method according to claim 12, wherein the updating the text to be processed based on the adjustment result comprises:
determining a text center position corresponding to the text to be processed before the adjusting the spacing adjustment object and a text center position corresponding to the text to be processed after the adjusting, respectively; and
shifting the text center position corresponding to the text to be processed after the adjusting to the text center position corresponding to the text to be processed before the adjusting, to obtain the text to be processed after the updating.

14. The text processing method according to claim 13, wherein the determining the text center position corresponding to the text to be processed before the adjusting the spacing adjustment object and the text center position corresponding to the text to be processed after the adjusting respectively, comprises:
for the text to be processed before the adjusting or after the updating, determining the text center position corresponding to the text to be processed based on a word center position corresponding to the words in the text to be processed.

15. The text processing method according to claim 1, further comprising:
in response to an information adjustment operation for second display information of a word or a character in the text to be processed, adjusting the second display information of the word or the character, wherein the second display information comprises at least one of language type information, a font style, color information, position information, and size information corresponding to the word or the character.

16. An electronic device, comprising:
one or more processors; and
a storage apparatus, configured to store one or more programs,
wherein the one or more programs, when executed by the one or more processors, enable the one or more processors to implement a text processing method, and the text processing method comprises:
acquiring and displaying a text to be processed, wherein the text to be processed comprises a plurality of words, and each of the plurality of words comprises at least one character;
determining a spacing adjustment object corresponding to the text to be processed in response to a spacing adjustment triggering operation for the text to be processed, wherein the spacing adjustment object comprises a word spacing and a character spacing that make up the text to be processed; and
adjusting the spacing adjustment object, updating the text to be processed based on an adjustment result, and displaying the text to be processed after the updating.

17. The electronic device according to claim 16, wherein the determining the spacing adjustment object corresponding to the text to be processed in response to the spacing adjustment triggering operation for the text to be processed, comprises:
in response to a selection triggering operation for a character and/or a word in the text to be processed, determining the spacing adjustment object corresponding to the text to be processed based on a word to which a selected character belongs and/or a selected word.

18. The electronic device according to claim 17, wherein the determining the spacing adjustment object corresponding to the text to be processed based on the word to which the selected character belongs and/or the selected word, comprises:
taking the word to which the selected character belongs and/or the selected word as at least one trigger word and determining an amount of the at least one trigger word; and
determining the spacing adjustment object corresponding to the text to be processed based on the amount of the at least one trigger word.

19. The electronic device according to claim 18, wherein the determining the spacing adjustment object corresponding to the text to be processed based on the amount of the at least one trigger word comprises at least one of the following operations:
in response to the amount of the at least one trigger word being one, taking the character spacing as the spacing adjustment object;
in response to the amount of the at least one trigger word being plural, taking the word spacing as the spacing adjustment object;
in response to the amount of the at least one trigger word being plural and at least part of the at least one trigger word being not adjacent in the text to be processed, taking the character spacing as the spacing adjustment object; and
in response to the amount of the at least one trigger word being plural and at least part of the at least one trigger word being adjacent in the text to be processed, taking the word spacing as the spacing adjustment object.

20. A storage medium, comprising computer-executable instructions, wherein the computer-executable instructions, when executed by a computer processor, are configured to implement the text processing method according to claim 1.
